(19) United States
(12) Patent Application Publication
(10) Pub. No.: US 2023/0281363 A1
(43) Pub. Date: Sep. 7, 2023

(54) OPTIMAL MATERIALS AND DEVICES DESIGN USING ARTIFICIAL INTELLIGENCE

(71) Applicant: International Business Machines Corporation, Armonk, NY (US)

(72) Inventors: Dzung Tien Phan, Pleasantville, NY (US); Robert Jeffrey Baseman, Brewster, NY (US)

(21) Appl. No.: 17/685,645

(22) Filed: Mar. 3, 2022

(51) Int. Cl. G06F 30/27

(52) U.S. Cl. CPC G06F 30/27; G06F 2111/06

(57) ABSTRACT

A system and method for optimizing materials and devices design. The method includes building machine learning models to predict a quality of target measurements based on an experimental design input by formulating a regularized multi-objective optimization to recommend the final experimental design using a logistic curve for the loss function and a model uncertainty quantification term for the final solution. Alternately, the system and method uses a black-box optimization for optimal process design that includes iteratively building a sequence of surrogate functions, where intermediate designs are generated to improve the quality of the surrogate function. Further a derivative-free optimization is performed that utilizes global optimization techniques (global search) with Gaussian process (local method) with a Bayesian optimization to produce a sequence of designs that leads to an optimal design. The system and method is used in machine learning/deep learning for tuning hyperparameters and an architecture search of prediction models.

### FIELD

The present disclosure relates generally to a method and system for manufacturing computer hardware products such as semiconductor integrated circuits (ICs) or memory chips, and more particularly, to an artificial intelligence (AI)-enabled accelerated process development framework that provides for optimization of experimental designs for manufacturing computer hardware.

### BACKGROUND

The design and manufacture of products, e.g., semiconductor ICs, microprocessors, memory chips, etc. has become increasingly complex in terms of finding optimal set of structures and material choices. Often, in a design process, there are multiple, frequently conflicting performance measures to be achieved.

As an example, FIG. 1 depicts a semiconductor device consisting of an MRAM stack 50 which includes at least a base MTJ portion having an inter layer 53, a reference layer 55, a tunnel barrier layer 58, a free layer 60, a cap layer 68, a top electrode layer 69. The fabrication of the MRAM devices can require optimization of a layer stack 50, with options for each layer and can require hundreds of manufacturing steps.

A multitude of experiments have been performed and multiple quality objectives have been tracked, e.g., for purposes of identifying an optimal processing, i.e., recipe sequences.

As an example, semiconductor memory device processing steps can include running a process to simultaneously achieve objectives such as: 1. Minimizing the write error rate; 2. Maximizing the read/write cycle; 3. Minimizing write pulse width; and 4. Minimizing the series resistance effect from the isolation transistor. It is thus the case that, in the processing of a single semiconductor memory device layer, there can be many complex multivariate input and multivariate output relationships.

Current practices to address such process design optimization include: performing an exploration with short loop experiments, product building with functional tests. This can include guiding the development by engineering judgement, aided by traditional domain expert.

It is the case however, that insight into simultaneous multiple functional objectives from short loop experiments may be limited and the exploration of multi-dimensional design space may be sparse. Further, the evaluation of progress towards multiple simultaneous conflicting objectives is difficult and extensive experimentation is time consuming and costly in terms of wafer processing and engineering activity.

### SUMMARY

A system, method and computer program product for accelerated process development, particularly using Artificial Intelligence (AI) for smarter design of experiments.

The system, method and computer program product combines techniques from machine learning and optimization to suggest an optimal experimental design that includes the development of multi-objective optimization with categorical predictors.

The system, method and computer program product combines techniques from machine learning and optimization to suggest an optimal experimental design that includes the development of black-box optimization for limited historical data cases.

In an embodiment, the use of techniques from machine learning and optimization to suggest an optimal experimental design can deal with both continuous and categorical design variables.

In one aspect, there is provided a method for multi-objective optimization in design of a physical device. The method comprises: receiving, at one or more hardware processors, an input data comprising multiple unique historical experimental designs associated with a building of a physical device and corresponding historical performance measurements obtained using the built physical device; receiving, at the one or more hardware processors, a specification of at least two target measurement values to be achieved by the built physical device; and running, using one or more hardware processors, a prediction model trained to recommend a new design used to build the physical device, the recommended new design for simultaneously achieving the at least two target measurement values by the physical device; and configuring, using the one or more hardware processors, one or more of: structures, materials, or process conditions used for building the physical device according to the recommended new design.

According to a second aspect, a multi-objective optimization method in design of a physical device. The method comprises: receiving, at one or more hardware processors, an input data comprising multiple unique historical experimental designs and corresponding historical performance measurements associated with a building of a physical device, the input data being insufficient for reliably training a single prediction function to predict a new design of the physical device that simultaneously achieves at least two target measurement values; iteratively obtaining, using the one or more hardware processors, a sequence of surrogate prediction functions, each surrogate prediction function of the sequence designed to learn a relationship between the input historical experimental design data used to build the physical device and the at least two target measurement values; running, at the one or more hardware processors, one of the successive surrogate prediction functions to optimally predict a new design for simultaneously achieving the at least two target measurement values by the physical device; and configuring, using the one or more hardware processors, one or more of: structures, materials, or process conditions used for building the physical device according to the predicted new design.

In a further aspect, there is provided a system for multi-objective optimization in design of a physical device. The system comprises: a hardware processor and a non-transitory computer-readable memory coupled to the processor, wherein the memory comprises instructions which, when executed by the processor, cause the processor to: receive an input data comprising multiple unique historical experimental designs and corresponding historical performance measurements associated with a building of a physical device, the input data being insufficient for reliably training a single prediction function to predict a new design of the physical device that simultaneously achieves at least two target measurement values; iteratively obtain a sequence of surrogate prediction functions, each surrogate prediction function of the sequence designed to learn a relationship between the input experimental historical design data used to build the physical device and the at least two target measurement values; run one of the successive surrogate prediction functions to optimally predict a new design for simultaneously achieving the at least two target measurement values by the physical device; and configure one or more of: structures, materials, or process conditions used for building the physical device according to the predicted new design.

In a further aspect, there is provided a computer program product for performing operations. The computer program product includes a storage medium readable by a processing circuit and storing instructions run by the processing circuit for running methods. The methods are the same as listed above.

### BRIEF DESCRIPTION OF THE DRAWINGS

FIG. 1 depicts generally a semiconductor device, e.g., an MRAM stack which includes multiple layers and subject to a design optimization in an embodiment herein;

FIG. 2 depicts a table representing a commas separated value (csv) of a data file that includes historical data that can be used in building of machine learning models that can predict a quality of target measurements when optimizing a design structure such as the MRAM stack device shown in FIG. 1;

FIG. 3 conceptually depicts a first embodiment of a “smart” experimental design system and method for developing a prediction model with a multi-objective optimization given enough historical data input;

FIG. 4A depicts a method of the first embodiment for multi-objective optimization when several target measurements are to be simultaneously optimized;

FIG. 4B depicts a simplified block diagram depicting a production process corresponding to a physical system shown in FIG. 4A, that receives input variables such as control (i.e., design) and uncontrolled inputs (i.e., fixed working environments);

FIGS. 5A and 5B each depict a respective chart plotting each of the respective terms of an example loss function formula [symbol] (x) for the example optimization targets to be simultaneously minimized and maximized and further depicting a resulting scalar based upon a given objective threshold value;

FIG. 6 shows a comparison of example optimized regression curve plots plotted as a function of multiple experimental designs along a horizontal axis

FIG. 7 depicts a method for constructing a prediction model using a black-box optimization approach for determining an experimental design that optimizes (i.e., maximizes or minimizes) a desired target value when there is not enough historical data for use in building the prediction model;

FIG. 8 shows a pseudocode depiction of a detailed iterative experimental design selection algorithm for identifying an optimal new experimental design in one embodiment;

FIG. 9A depicts the converting of a search space into a unit hyper cube used and an initial subsequent partitioning of the hyper-cube for use in identifying a next optimal experimental design according to the black-box optimization approach;

FIG. 9B depicts successive iterations of an example global search for selecting hyper-rectangles and their partitioning for use in identifying a next optimal experimental design according to the black-box optimization approach;

FIG. 10 visually depicts the building of a new prediction function using example results of a global search conducted at an iteration in an experimental design selection method step for finding optimal hyper-rectangles in a combination with results of a local search strategy;

FIG. 11 depicts an example black-box optimization system framework for data-driven materials design in one embodiment; and

FIG. 12 illustrates an example computing system in accordance with an embodiment.

### DETAILED DESCRIPTION

There is disclosed a “smart” design system and method. In non-limiting embodiments, the “smart” design system and method includes a designing of experiments.

In particular, an AI enabled accelerated process development framework includes a computer-implemented “smart” system and method applied to identify an optimal experimental design.

In a first embodiment of an AI enabled accelerated process development framework, there is implemented a “smart” design system and method that provides a multi-objective optimization solution for enough historical data with categorical predictors.

In a second embodiment of an AI enabled accelerated process development framework, there is implemented a “smart” design system and method that provides a black-box optimization solution for limited data cases to identify an optimal process design.

In illustrative, non-limiting embodiments, the system and methods are advantageously applied for the field semiconductor manufacturing where there is an increasingly complex set of structures and material choices, and multiple, frequently conflicting performance measures to be achieved.

The “smart” design system and methods for optimizing material design further achieves the purpose of using less experimental time with a high-quality recommendation for design. That is, the system and methods help to reduce the number of experimental runs while ensuring the finding of designs of high quality (i.e., a better target value). In an embodiment, the system and method are implemented on a computer system for generating a sequence of designs that leads to optimal design, i.e., achieves optimizing multi objectives simultaneously. In an example application involving optimizing an integrated circuit design, e.g., microprocessor or computer memory device, where target values can include, but are not limited to: logic circuit density, a number of transistors, a distance between transistors, etc.

For non-limited purposes of illustration, the “smart” design system and method is applied to designing a random access memory (RAM) device, in particular, identifying an optimal set of structures, geometries, materials, and process conditions.

In the first embodiment, the “smart” design system and method develops a multi-objective optimization solution given enough historical data and implements the building of machine learning models to predict a quality of target measurements based on an experimental design input. The first “smart” design system and method further implements formulating a regularized multi-objective optimization solution for recommending a final experimental design.

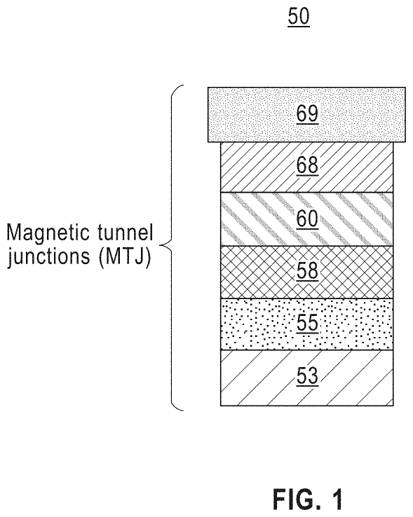

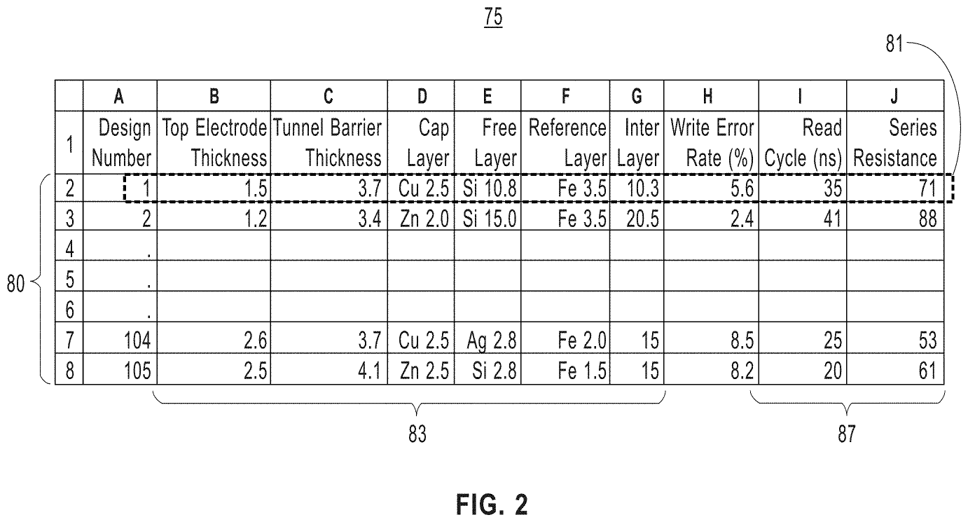

FIG. 2 depicts a table 75 representing a commas separated value (csv) format data file that includes historical data that can be used in building of machine learning models that can predict a quality of target measurements when designing an optimal RAM device such as the MRAM stack device 50 shown in FIG. 1. Table 75 including multiple rows 80 with each row 81 depicting a unique experimental design for the MRAM stack 50 and each column of multiple columns 83 representing an experimental design value. As shown in this example, there are 105 unique experimental designs (i.e., 105 rows), with each column comprising a design value, e.g., for the particular MRAM layers, e.g., seed layer, free layers, capping layers, etc. The final columns 87 include the target measurements for use in evaluating the particular design (process design optimization). For example, a possible design value for each layer (at a row/column intersection) can include a data structure specifying design variables such as: a numeric value representing a material layer thickness, a categorical value indicating a particular material of the layer, and a categorical value indicating a particular semiconductor process or working condition to be applied to form that layer. The table 75 of FIG. 2 shows an example of multiple unique experimental designs, e.g., 105 unique value rows, e.g., when target column measures are not included. Along a row, the respective target column measures represent a target measurement of a product (e.g., wafer or chip) resulting from the experimental design variables of that particular row that either need to be maximized (achieve a highest value, the read cycle as an example), minimized (achieve a lowest value, the write error rate as an example) or approach as nearly as possible to some specified value. There can be a multitude of different possible recipes and physical recipes for all possible manufacturing steps in a route. In this first embodiment, the historical data sufficiently covers the search space such that the prediction model accurately learns the relationship between an experimental design and a target measurement. Optimizing the regression function obtains a new design. While a multitude of experiments have been done, multiple quality objectives are required to be tracked with the potential of some measurements being noisy. In an embodiment, the data of table 75 shown in FIG. 2 is provided as input to a computer system running methods for building the “smart” design system and method that provides a multi-objective optimization solution. A further example can include the optimization of an integrated circuit design such as a microprocessor or computer memory device. In such application, the table 75 can include rows of unique experimental design variable inputs, e.g., historical circuit and logic designs, conductor routing, layouts etc. with corresponding target performance measurements for the chip design problem.

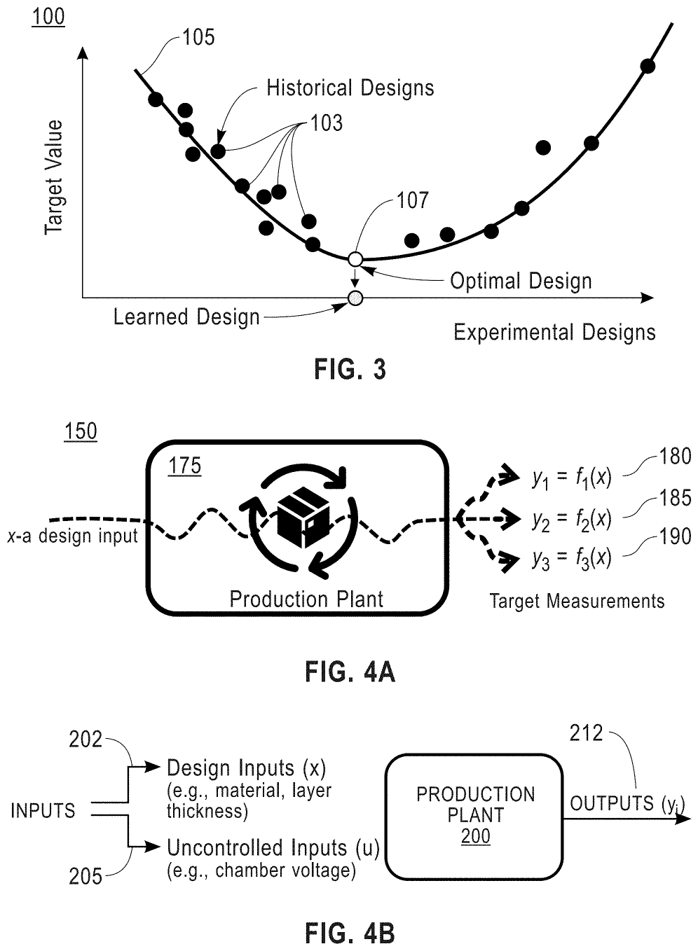

FIG. 3 conceptually depicts the first embodiment of a “smart” experimental design system and method for developing a prediction model with a multi-objective optimization given enough historical data input. In the first embodiment, based on this experimental design input data, the system builds a machine learning model to predict a quality of target measurements and formulate a regularized multi-objective optimization to recommend a final experimental design.

As shown in FIG. 3, there is depicted the method 100 for constructing a prediction model used for determining an experimental design used for optimizing (i.e., maximizes or minimizes) a desired target value. The prediction model is a regression function or curve 105 that that learns reliably the relationship between input historical designs and output measurement values. This curve 105 is optimized to fit the respective unique historical designs 103 (plotted along the horizontal axis) against their respective target measurement values (plotted along the vertical axis for that unique historical experimental design). Once the prediction model is built reliably from the multiple types of unique experimental historical designs, the prediction model 105 of FIG. 3 can be used to determine a new optimal design 107 to optimize a target value, for example. That is, regression function or curve 105 can be learned based on the table of historical experimental design data such as shown in FIG. 2 and on their respective target value measurements, and curve 105 can be used (i.e., optimized) to determine a next (optimal) design 107 for a target measurement value, e.g., to be minimized or maximized.

Characteristics of this first embodiment include: 1. The historical dataset sufficiently covers the search space for experimental designs; 2. There is no need to produce several new experiments in order to identify an optimal design; and 3. for a mixed type of variables (e.g., continuous and categorical), a random forest supervised machine learning algorithm can be used based upon growing and the merging together of multiple decision trees.

FIG. 4A depicts the method of the first embodiment for multi-objective optimization, i.e., when several target measurements are to be simultaneously optimized, e.g., some being maximized or minimized. As shown in FIG. 4A, there is depicted a multi-objective prediction optimization problem 150 in which a physical system 175 includes operations embodied as one or more functions, e.g., ƒ₁(x), ƒ₂(x), ƒ₃(x), etc., operating on one or more experimental design input variables x to produce a respective multiple target measurement output y₁, y₂, y₃ where:

y₁=ƒ₁(x)180;y₂,ƒ₂(x)185 and y₃=ƒ₃(x)190

FIG. 4B depicts a simplified block diagram depicting a production plant 200 corresponding to the physical system 175 of FIG. 4A, that receives input variables such as control variables (x), e.g., representing a design input, for example, layer thickness 202, and fixed variables (u) which are uncontrolled inputs 205, e.g., a voltage value, and generates outputs (yₖ) 212.

In the first embodiment of the prediction multi-objective optimization problem, there is generated the optimization objective function where the objective is to optimize simultaneously target measurements with different ranges of values according to:

minₓy= [symbol] (f₁(x,u),f₂(x,u), . . . )+a model uncertainty quantification term

where [symbol] ( ) is a target function, and lb (lower bound)≤x≤ub (upper bound). The model uncertainty quantification term is a regularization term quantifying the prediction uncertainty of prediction models f₁(x,u), f₂(x,u), . . . . In an embodiment, the model uncertainty quantification term is the R-squared value for a sub-region for partition-based regressions. In an embodiment, a model uncertainty quantification term is the mean squared error for a sub-region for partition-based regressions. In an embodiment, a model uncertainty quantification term is the penalty term calculated from principal component analysis (PCA).

Generalizing to a system having input variables x where the objective is to optimize simultaneously multiple target objectives (measurements) with different ranges of values, the multi-objective optimization problem becomes:

minₓy= [symbol] (f₁(x,u),f₂(x,u), . . . )+a model uncertainty quantification term

where [symbol] is the target function for multi-objective optimization with thresholds and lb≤x≤ub. The model uncertainty quantification term quantifies the prediction uncertainty of prediction models f₁(x,u), f₂(x,u), . . . . In an embodiment, a model uncertainty quantification term is the R-squared value for a sub-region for partition-based regressions. In an embodiment, a model uncertainty quantification term is the mean squared error for a sub-region for partition-based regressions. In an embodiment, a model uncertainty quantification term is the penalty term calculated from principal component analysis (PCA).

In a non-limiting example, using four (4) example target optimizations for the MRAM stack design optimization, the objectives to be optimized are: Minimizing the write error rate; 2. Maximizing the read/write cycle; 3. Minimizing write pulse width; and 4. Minimizing the series resistance effect from the isolation transistor. Each target measurement has a desired value threshold.

In an embodiment, the target function is a logistic curve set forth according to:

$$ℒ ( f ( x ) , \overline{f} ) = \frac{h}{1 + {e}^{- r * ( f ( x ) - f )}}$$

where h is a parameter representing the high (upper asymptote, for example, h=1) of the curve, r is a parameter representing the logistic growth rate (curve steepness, for example, r=0.5), and f̅ is the objective threshold or desired target value, for example f̅=0.05% for the write error rate. This target function [symbol] generates a single, scalar value.

Thus, for the n optimization targets there is provided a target function as follows:

$$ℒ ( {f}_{1} ( x ) , {f}_{2} ( x ) , {f}_{3} ( x ) , … , {f}_{n} ( x ) ) = \frac{{h}_{1}}{1 + {e}^{- {r}_{1} * ( {f}_{1} ( x ) - {\overline{f}}_{1} )}} - \frac{{h}_{2}}{1 + {e}^{- {r}_{2} * ( {f}_{2} ( x ) - {\overline{f}}_{2} )}} + \frac{{h}_{3}}{1 + {e}^{- {r}_{3} * ( {f}_{1} ( x ) - {\overline{f}}_{3} )}} … - \frac{{h}_{n}}{1 + {e}^{- {r}_{n} * ( {f}_{n} ( x ) - {\overline{f}}_{n} )}}$$

This target function [symbol] generates a single, scalar value from several target measurements ƒ₁(x), ƒ₂(x), ƒ₃(x), . . . , ƒₙ(x). The negative sign (−) between terms represent the logistic curves having targets to be maximized and a positive sign (+) between terms represent the logistic curve having targets to be minimized.

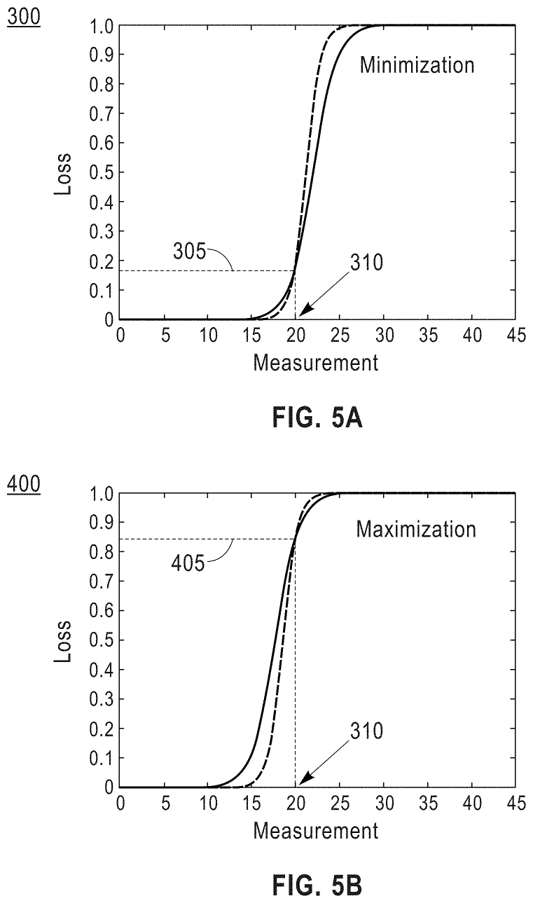

FIG. 5A depicts a chart 300 plotting each of the respective terms of the example target function formula [symbol] ( ) for the example optimization targets to be simultaneously minimized, e.g., write error rate and series resistance, and further depicting a resulting scalar value 305 based upon a given objective threshold value 310. Likewise, FIG. 5B depicts a chart 400 plotting each of the respective terms of the example target function formula [symbol] ( ) for the example optimization targets to be simultaneously maximized, e.g., read cycle and write cycle, and further depicting a resulting scalar value 405 based upon a given objective threshold value 410.

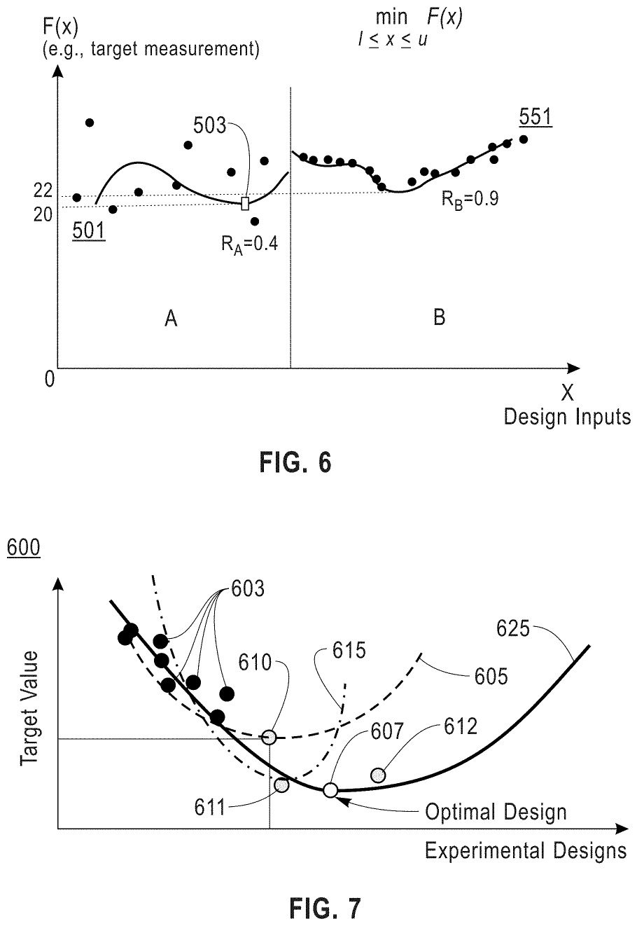

FIG. 6 shows a comparison of example optimized regression curve plots 501, 551 when solving minₓ F(x), plotted as a function of a multiple experimental designs along the horizontal axis where prediction function F(x):= [symbol] (ƒ₁(x), ƒ₂(x), . . . )+a model uncertainty quantification term, where x∈ [symbol] . F(x) is formed by two curve plots 501, 551. In FIG. 6, a first example regression curve plot 501 represents an optimized portion of a prediction model F(x) fitted to a variety of output target measurements (training points) as function of the respective experimental designs (variable) x in a first region labeled region “A” while the second example regression curve plot 551 represents an optimized portion of a prediction model F(x) fitted to a variety of output targets as function of the respective experimental designs (variable) x in a second region labeled region “B”. Comparing regression curve plot 501 against the regression curve plot 551 in FIG. 6, the plot of F(x) in region A represents a higher function value for F(x) (i.e., F(x)=20) but also a high model uncertainty (the r-squared value for region A is R_{A}=0.4), e.g., a value 503 in region A may lead to a poor decision since the prediction accuracy around the optimization solution is low. In distinction, the optimized solution in the region B is more trustworthy over that in the region A as region B has more training points and the prediction model in Region B has high accuracy (the r-squared value for region B is R_{B}=0.9).

Referring still to FIG. 6 depicting a comparison of example optimized regression curve plots 501, 551, when solving minₓ F(x), plotted as a function of a multiple experimental designs along the horizontal axis, the plots 501, 551 depict a further example of a resulting optimization and model uncertainty for a partition-based regression employing decision tree regression or multivariate adaptive regression splines (MARS) analysis used for selecting important descriptors during the prediction model training, where it is supposed that model fidelities Rᵢ are available for subregions (such as R-squared and accuracy). In an embodiment, the optimization including the target function [symbol] (x) and a regularizer λΣuᵢ Rᵢ is defined as follows:

min [symbol] (f1(x),f2(x), . . . )−λΣuᵢRᵢ subject to Σuᵢ=1,uᵢ∈{0,1}

where x∈ [symbol] is the design input variable. The index i is a subregion for the space of design inputs of the prediction model, λ is a weight factor depending upon model complexity, uᵢ∈{0, 1} and where uᵢ=1 for routing x to region i, and Rᵢ are model fidelities available for subregions where the R value is a value measuring how good the model learns the data for each subregion and is a value between 0 and 1 (with values closer to 1 being more accurate or less model uncertainty). Thus, as shown in FIG. 6, for example plot 501 modeling uncertainty in region A, the corresponding model fidelity R_{A}=0.4 while example plot 551 modeling uncertainty in region B, the corresponding model fidelity R_{B}=0.9 indicating less model uncertainty in region B.

Referring still to FIG. 6 depicting a comparison of example optimized regression curve plots 501, 551 when solving minₓ F(x), plotted as a function of a multiple experimental designs along the horizontal axis, the plots 501, 551 depict a further example of a resulting optimization and model uncertainty for a general function regression where a solution close to many training points in a lower-dimensional hidden subspace is desirable. In an embodiment, the method optimizes the target function F(x) (i.e., F(x)= [symbol] (x)) and a model uncertainty quantification term g(x) is computed as follows:

$${min}_{x ∈ {R}^{n}} F ( x ) + g ( x )$$

where, for linear-based optimization approach, the model uncertainty quantification term becomes:

$$g ( x ) = λ {\sum }_{i = 1}^{n} \vert {x}_{i} - {e}_{i}^{T} {UU}^{T} x \vert$$

where eᵢ is the i-th basis vector in Rⁿ, U is the matrix of principal components computed by principal component analysis (PCA), U^{T} is the transpose of U. For a non-linear optimization approach, the model uncertainty quantification term becomes:

$$g ( x ) = λ {\sum }_{i = 1}^{n} {( {x}_{i} - {e}_{i}^{T} {UU}^{T} x )}^{2}$$

The computing of the model uncertainty quantification terms, whether based upon R-squared values for decision tree and MARS regression or whether using PCA regularization approach yielding g(x), is implemented for obtaining a higher quality for decision solution for the plot 551 over Region B shown in FIG. 6 to best address the model uncertainty in that region.

In an embodiment, the model uncertainty quantification term based upon R-squared values becomes

$$g ( x ) = - λ {\sum }_{i = 1} {u}_{i} {R}_{i}$$

In an embodiment, the system and method can be conducted for optimal process design, e.g., for a semiconductor MRAM circuit, and is conducted in a manner that identifies optimal processing (recipe sequences) and can be used in guiding future experiments.

For instance, once an optimal prediction function F(x) solution is generated, it can be used to propose a new experimental design that achieves one or more specified target measurements of the physical device, e.g., a semiconductor device. Consequently, one or more of: structures, geometries, materials, or process conditions of tools used for building said physical device according to said predicted new design can be modified according to the proposed new design.

In the second embodiment of an AI enabled accelerated process development framework, there is implemented a “smart” design system and method that provides a black-box optimization solution for limited data cases. In this black-box optimization approach of the second embodiment, the historical data does not sufficiently cover the search space thereby providing a high uncertainty resulting in an inability to build a single prediction function that optimizes the regression function. This uncertainty corresponds to the modeling uncertainty shown in region A of FIG. 6. This second approach thus requires a building of a number of regression functions gradually and as more experiments are collected the prediction function improves.

In an embodiment, this second approach implements the optimizing of a sequence of surrogate (prediction) functions to suggest a final optimal design, and intermediate designs are generated to improve the quality of the surrogate function. The second “smart” design system and method further implements a derivative-free optimization by utilizing global optimization techniques with Bayesian optimization to produce a sequence of designs that leads to an optimal design.

FIG. 7 depicts a method 600 for constructing a prediction model using a black-box optimization approach for determining an experimental design that optimizes (i.e., maximizes or minimizes) a desired target value when there is not enough historical data for use in building the prediction model. That is, the plot of FIG. 7 shows a horizontal axis depicting multiple types of unique experimental historical designs and a vertical axis depicting corresponding measured target values for the respective unique historical experimental designs. The method forms a black box optimization problem when the historical dataset of experimental designs 603 does not sufficiently cover the search space for experimental designs. Given a plot of an insufficient number of unique historical experimental designs 603, the method builds a regression curve to fit the respective design points 603. However, in the black-box optimization approach, the method successively creates several new experiments in order to identify an optimal design. As an example, as shown in FIG. 7, the method builds a regression function (prediction function) 605, the next sample experimental design data point 610 is obtained by minimizing the prediction function 605. In a subsequent iteration, the method adds a new sample datapoint to a set of training experimental designs, e.g., a new training datapoint 610, and builds a new regression function 615 using both the respective design points 603 and the new datapoint 610, that more accurately learns the relationship between the design points and the target value. The method optimizes the regression function 615 to obtain the next design 611. After two more iterations, the method adds two new added training datapoints 611 and 612 that results in building the new regression function 625 which can serve as the experimental design prediction model and be used to determine an (optimal) design 607 for a target measurement value, e.g., to be minimized or maximized.

The optimal process design for adding new experiments to construct the new regression function can be formulated as the process of solving the following black-box optimization problem f set forth in equation (1) as follows:

$${min}_{x ∈ Ω ∈ {ℝ}^{p}} f ( x ) \qquad ( 1 )$$

where f is a black-box function, Ω is the box constraint defined as l≤x≤u, and x is an experimental design such that l≤x≤u where/is a lower bound, u is an upper bound. It is assumed that f: [symbol] → [symbol] does not have closed-form formula, function evaluations are costly; furthermore, its gradient is unavailable.

Given a dataset of k historical designs {(x₁, ƒ₁), . . . , (xₖ, ƒₖ)}, where xᵢ is the product design, ƒᵢ is the target value, a method is run to suggest the new design xₖ₊₁. First, the method scales the search space between 0 and 1, i.e., the method includes converting the search space into a unit hyper cube according to:

Ω={x∈ [symbol] :0≤xᵢ≤1}. (2)

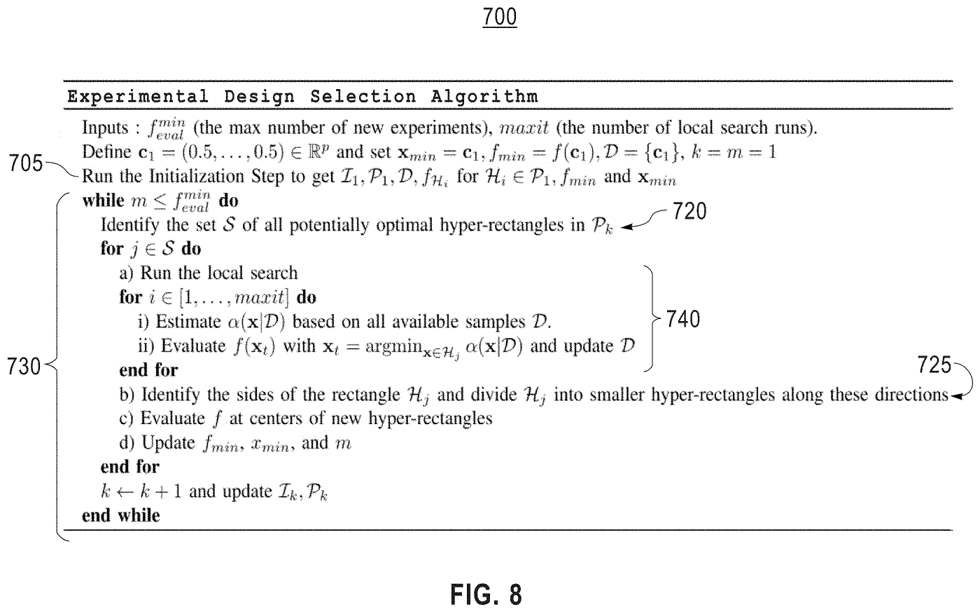

FIG. 8 shows a pseudocode depiction of a detailed iterative experimental design selection algorithm 700 for identifying an optimal new experimental design. The method 700 of FIG. 8 includes a spatial partition global algorithm to quickly identify an optimal solution under the computation budget constraint, i.e., the limit on the number of new experimental designs. In an embodiment, the method implements an iterative While-Do loop 730 limited by the maximal number of function evaluations. The iterative scheme performs, at each iteration, two main functions: first, at 720, there is used a global search strategy to identify a set of potentially optimal hyper-rectangles, where the sub-regions are expected to contain a global optimal solution. A second step is performing a local search Gaussian process over the potentially optimal hyper-rectangles as indicated within an iterative process shown in “For” loop 740. The next experimental design is obtained from running the local search over a potentially optimal hyper-rectangle.

At 705, FIG. 8, there is defined: [symbol] as the index set of all generated hyper-rectangles at an iteration value k (i.e., k-th iteration) and let [symbol] ₖ is the set of hyper-rectangles [symbol] ᵢ, e.g., [symbol] ₖ={ [symbol] ᵢ: i∈ [symbol] }.

Here, [symbol] ᵢ={x∈ [symbol] : 0≤lᵢ≤x≤uᵢ≤1} is a hyper-rectangle in the partition of Ω for some bounds lᵢ and uᵢ. There is further denoted [symbol] as the best prediction function value of f over [symbol] ᵢ (i.e., by evaluating at the sampling points in the sub-region [symbol] ᵢ including its center cᵢ). ƒₘᵢₙ and xₘᵢₙ are the best function value and the best feasible solution over Ω, respectively. The variable m is used to count the number of function evaluations and m_{feval}^{max} is the maximal number of function evaluations. D is the set of all sampled points. Iteration index value k and index m are initialized as a value 1.

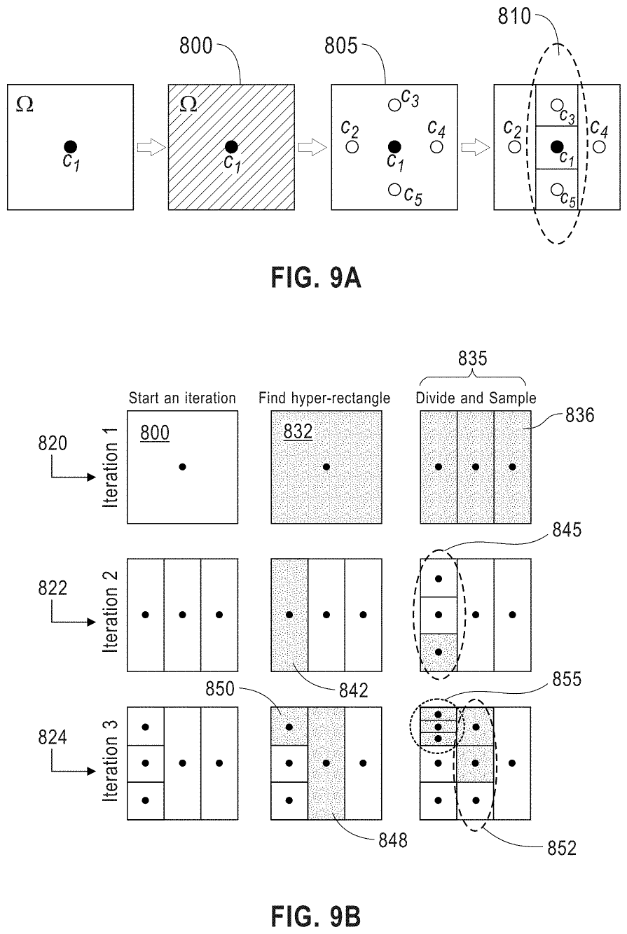

As shown in FIG. 9A, in a further initialization step for generating new experimental designs, at 800, after converting the search space for a next optimal experimental design into a unit hyper cube Ω, there is followed a step of finding ƒ₁=ƒ(c₁) where c₁ is the center of Ω and, at 805, dividing the hyper-cube Ω by evaluating the function values at 2p points cᵢ±δeᵢ, i∈{1, . . . , p}, e.g., where

$$δ = \frac{1}{3}$$

and eᵢ is the i-th unit vector. The method then selects a hyper-rectangle with a small function value in a large search space to which the small function value is defined as:

sᵢ=min{f(cᵢ+δeᵢ),f(cᵢ−δeᵢ)},∀i∈{1, . . . ,p}

and the dimension with the smallest sᵢ is partitioned into thirds depicted at 810, FIG. 9A. Returning to FIG. 8, at 705, there is further initialized sets [symbol] ᵢ, [symbol] values [symbol] for every [symbol] ∈ [symbol] ₁, and update ƒₘᵢₙ=min{ƒ_{H}_{ᵢ}: [symbol] ᵢ∈ [symbol] ₁} and corresponding xₘᵢₙ.

With respect to the global search strategy at 720, FIG. 8, to identify a set of potentially optimal hyper-rectangles [symbol] ᵢ, there is further performed the following:

Let ∈>0 be a small positive constant and ƒₘᵢₙ be the current best function value over Let I be the set of indices of all existing hyper-rectangles. Let ƒ_{H}_{ᵢ} be the function value estimated at the center cᵢ of [symbol] ᵢ and dᵢ be the distance from the center of hyper-rectangle Hi to its vertices. ƒ_{median} is the median of all function values in history.

A hyper-rectangle [symbol] ⱼ is potentially optimal if there exists a parameter K>0 such that the following condition is satisfied:

ƒ [symbol] _{ⱼ}−K×Vⱼ≤ƒ [symbol] _{ᵢ}−K×Vᵢ,∀i∈[m]

ƒ [symbol] _{ⱼ}−K×Vⱼ≤ƒₘᵢₙ−∈|ƒₘᵢₙ−ƒ_{median}|,

where Vⱼ is one half of the diameter of the hyper-rectangle [symbol] ⱼ.

In an alternate embodiment, the set of potentially optimal hyper-rectangles is identified as follows. For each j∈ [symbol] , let [symbol] ₗ={i∈ [symbol] : dᵢ<dⱼ}, [symbol] _{b}={i∈ [symbol] : dᵢ>dⱼ}, [symbol] ₑ={i∈ [symbol] : dᵢ=dⱼ} and

$${g}_{i} = \frac{{f}_{{ℋ}_{i}} - {f}_{{ℋ}_{j}}}{{d}_{i} - {d}_{j}} ,$$

∀i≠j. Find the set S by determining all hyper-rectangles [symbol] ᵢ satisfying three following conditions:

$$( a ) \leq {f}_{{ℋ}_{j}} \qquad ( 3 )$$

$$for every i ∈ {e}_{} ;$$

$$( b ) {max}_{i ∈ {I}_{l}} {g}_{i} \leq {min}_{i ∈ {I}_{b}} {g}_{i} ; \qquad ( 4 )$$

$$( c ) If {f}_{median} > {f}_{min} then$$

$$ϵ \leq \frac{{f}_{min} - {f}_{{ℋ}_{j}}}{\vert {f}_{min} - {f}_{median} \vert} + \frac{{d}_{j} {min}_{i ∈ {I}_{b} {g}_{i}}}{\vert {f}_{min} - {f}_{median} \vert} \qquad ( 5 )$$

otherwise,

[symbol]

≤dⱼ min_{i∈l}_{_{b}}gᵢ+ƒₘᵢₙ (6)

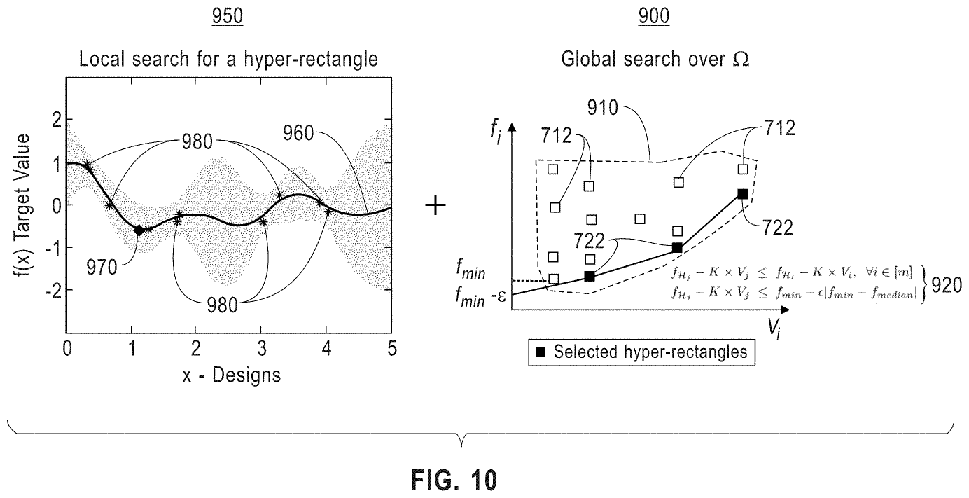

FIG. 10 is a visual depiction of the combination of global search 900 conducted at an iteration in the experimental design selection method step 720 and local search for hyper-rectangles in step 740, FIG. 8 for finding an optimal experimental design. The global search 900 of FIG. 10 shows a current search space 910 including a set of hyper-rectangles 712 and the results of the method step for determining which hyper-rectangles 712 are potentially optimal by satisfying the condition 920 corresponding to equations (3-6). A hyper-rectangle 712 contains an infinite number of design points. That is, in the example depicted in FIG. 10, hyper-rectangles 712 would be selected as satisfying this condition 920. These selected sub-rectangles 722 would then be subject to further partitioning in a next iteration. When a hyper-rectangle is identified as potentially optimal, the local search 950 forms a prediction function 960 over historical experimental designs 980. The local method optimizes the prediction function 960 to obtain the next design 970.

Returning to the method of FIG. 8 at 725, once a hyper-rectangle has been identified as potentially optimal, subsequent iterations divide this hyper-rectangle into smaller hyper-rectangles. The method 700 only splits the dimension with the longest width. In k-th iteration, for any potentially optimal hyper-rectangle [symbol] ∈ [symbol] ₖ with center c, let J⊂{1, . . . , p} be the index set such that the j-th dimension has the longest width w for any j∈J. Following the same idea in the initialization step, the algorithm 700 of FIG. 8 divides the selected hyper-rectangle [symbol] by maximizing the prediction function in 2|J| hyper-cubes centering at

$$c + \frac{w}{3} {e}_{j}$$

$$and$$

$$c - \frac{w}{3} {e}_{j}$$

with width

$$\frac{w}{3}$$

for j∈J. The dimension with largest prediction function value will be selected and is partitioned into thirds. This scheme continues until all dimensions in J are split.

FIG. 9B conceptually depicts the implementation of the global search strategy of FIG. 8, step 720 for iteratively identifying a set of potentially optimal hyper-rectangles and the partitioning of each into smaller hyper-rectangles. As shown in FIG. 9B, there is depicted successive iterations 820, 822, 824 of the example global search for selecting hyper-rectangles and their partitioning. For example, iteration 820 starts with an initial search space 800 and its selection at 832 as a hyper-rectangle and its partitioning into three sub-rectangles 835 having potential experimental design solutions. In FIG. 9B, the global search at 820 implements partitioning of the initial search space Ω (of experimental designs) into thirds and the sampling of each partition 836 to determine which satisfies the partitioning condition. At each subsequent iteration 822, 824, there is determined the set S of hyperrectangles and identify which hyperrectangle to further investigate and to further partition. For example, in iteration 822, a selected potentially optimal hyper-rectangle 842 is found to satisfy the partitioning condition, and a next step performs a further sub-dividing of the selected hyper-rectangle into thirds as shown as sub-rectangles 845. Then, at a next iteration 824, there are shown a result of a global search set S of five potentially optimal hyper-rectangles and in the example depicted, a determining that two hyper-rectangles 848, 850 satisfy the partitioning condition. The potentially optimal hyper-rectangle 848 is then further partitioned into three sub-rectangles 852 with each to be further investigated. Additionally, at the third iteration 824, the potentially optimal hyper-rectangle 850 is further partitioned into three sub-rectangles 855 with each to be further investigated for further partitioning.

In an embodiment, for the local search strategy 740, FIG. 8, there is built a prediction function over the selected sub-rectangle for estimating a likelihood of the prediction function ƒ(x) values over that region. Returning to FIG. 8, this optimization is depicted as a local search steps 740 and shown in FIG. 10 as a plot of the potential ƒ(x) function 960 having a value evaluated along the horizontal axis as a function of a potential experimental design x along the horizontal axis.

FIG. 10 conceptually depicts further results of a local search strategy 950 corresponding to method steps 740, FIG. 8, such that, when combined with the results of the global search 900, the method builds a new prediction function ƒ(x) 960, which can then be optimized to build a new experimental design x 970, and in the case of the example method 700, a prediction function α(x|D) and experimental design xₜ. This new optimal design can be built from new observations 980 (new arriving data corresponding to a limited number of design experiments x) and their respective expected utility according to a defined utility function 960.

To conduct a local search on a potentially optimal hyper-rectangle, a Gaussian process is used to build a prediction function 960 to approximate the unknown target function (ƒ). In FIG. 8, for local search 740, at iteration t, given Dₜ={(x₁, y₁), . . . , (xₜ, yₜ)} where yᵢ=ƒ(xᵢ), under the Gaussian process prior the predictive distribution for ƒ(x) at any point x is a Gaussian distribution with its mean μᵢ(x)=k_{T}K⁻¹y_{1:t} and covariance σₜ²(x)=k(x,x)−k^{T}K⁻¹ k, where K∈ [symbol] has entries k(xᵢ, xⱼ) (kernel) and k=[k(x₁, x), . . . , k(xₜ, x)]^{T}.

A prediction function is defined as

α(x|Dₜ)=μₜ(x)+κσₜ(x)

for some κ>0.

In an embodiment, the mean function μ(x) is assumed as a zero function. The covariance matrix k(x, x′) is used to model the covariance between any two function values ƒ(x) and ƒ(x′). Two examples for kernels are:
1) Power exponential kernel:

$$k ( x , {x}^{′} ) = exp ( - \frac{{\vert x - {x}^{′} \vert}^{2}}{2 {ℓ}^{2}} )$$

2) Màtern kernel:

$$k ( x , {x}^{′} ) = \frac{{2}^{1 - v}}{Γ ( v )} {( \frac{\sqrt{2 v} \vert d \vert}{ℓ} )}^{v} {K}_{v} ( \frac{\sqrt{2 v} \vert d \vert}{ℓ} )$$

where d=x-x′, and K_{ν} is the modified Bessel function. One common selection for the parameter is ν=5/2, where the kernel function is reduced to:

$$k ( x , {x}^{′} ) = ( 1 + \sqrt{5} \vert d \vert + \frac{5 {\vert d \vert}^{2}}{3 ℓ} ) exp ( - \frac{5 \vert d \vert}{ℓ} ) .$$

In a sequential experimental design setting, the next design is chosen by minimizing the prediction function. Typically, the prediction function α(x|Dₜ) is defined such that peak values would correspond to potentially high values of the objective function due to either high prediction or high uncertainty. Two potential prediction functions presented for α(x|Dₜ) include:

1) Expected improvement (EI): The expected improvement with respect to the best function value yet seen ƒₜ*=max{ƒ(x₁), . . . , ƒ(xₜ)} is defined by:

EI(x)= [symbol] [ƒ(x)−ƒₜ⁺]⁺ (7)

where a⁺=max(a, 0). Based on the GP posterior, one can easily compute such expectation, yielding:

EI(x)=σ(x)( [symbol] Φ(z)+φ( [symbol] )) (8)

where

$$z = \frac{μ ( x ) - {f}_{t}^{*}}{σ ( x )}$$

and φ(·), Φ(·) represent the probability density function (pdf) and cumulative distribution function (cdf) of the standard normal distribution respectively;
2) Upper confidence bound (UCB): UCB considers the combination of mean and variance

UCB(x)=μ(x)+κσ(x) (9)

as the prediction function.

In an example application, the black-box optimization approach herein may be employed in the domain of semiconductor manufacturing as the prediction model can provide for an optimal design of a physical device and/or optimize one or more of: structures, geometries, materials, or process conditions used for building the physical device according to a predicted optimal design. For example, once an optimal prediction function ƒ(x) solution is generated, it can be used to propose a new experimental design that achieves one or more specified target measurements of the physical device, e.g., a semiconductor device. Consequently, a tool or process used for building the physical device and/or a material of the physical device can be modified according to a proposed new design.

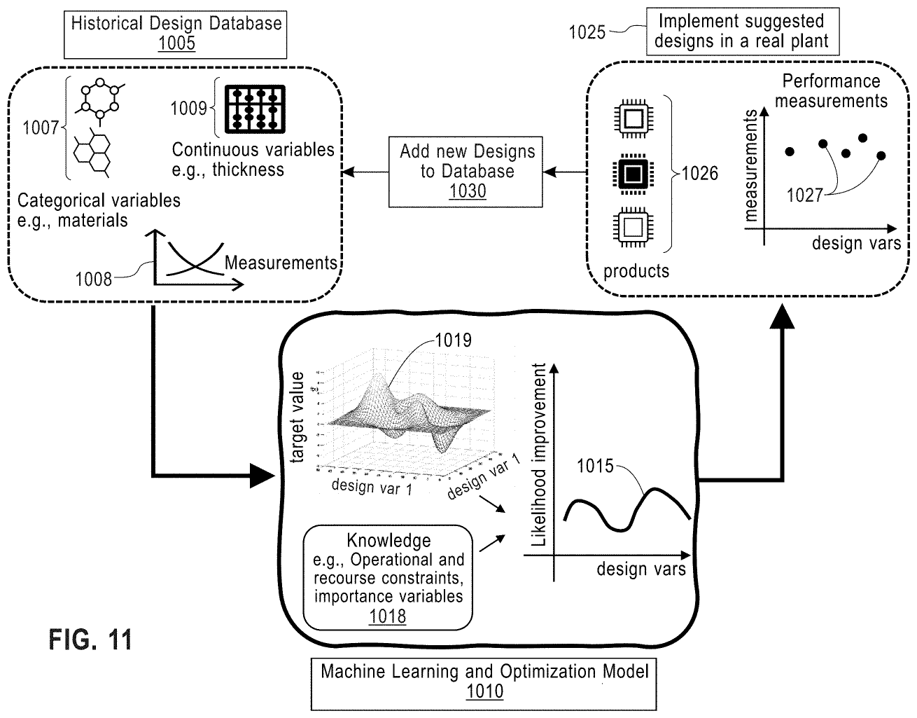

FIG. 11 depicts an example black-box optimization framework 1000 for data-driven materials design. As shown the system 1000 of FIG. 11, the system comprises an initial dataset or a database 1005 which includes storage of data such as discrete variables data 1007, such as material compositions, continuous variables data 1009, e.g., such as material layer thicknesses, performance measurements 1008, e.g., resistance. Such data is input to a black box optimization model 1010 used to build a prediction function ƒ(x) 1019. The prediction function 1019 and domain knowledge constraints 1018, e.g., operational constraints, are used to build an expected improvement function 1015. The model 1010 is a black-box prediction function ƒ(x) 1015 for optimizing a performance 1019 of a material structure given the myriad of discrete and continuous material design variables 1007, 1009 and measurements 1008. Using the approach of FIGS. 8-10, and operating under a resource constraint, the experimental design selection method can search structural and material designs 1026 and identify new experiment designs 1025 for getting performance measurements 1027. The optimizing black-box model 1010 can be updated as new augmented data 1030 is made available as a result of conducting experiments in accordance with new designs 1026 and performance measurements 1027. Advantageously, the black-box design optimization framework ensures the finding of optimal product designs of high quality while reducing a number of experimental runs (i.e., achieves a better target measurement value in a reduced experimental time).

Other applications using the system and methods of the present invention include applications and uses for Internet-of-Things technology, machine learning/deep learning model hyperparameter tuning, collection of data to improve accuracy for machine learning models. architecture search of prediction models, and tuning parameters for simulators and numerical algorithms. Other applications using the system and methods of the present invention include optimizing a chip design including identifying experimental design variable inputs, including but not limited to: logic circuit density, a number of transistors, a distance between transistors, etc., and target performance measurements for the chip design problem.

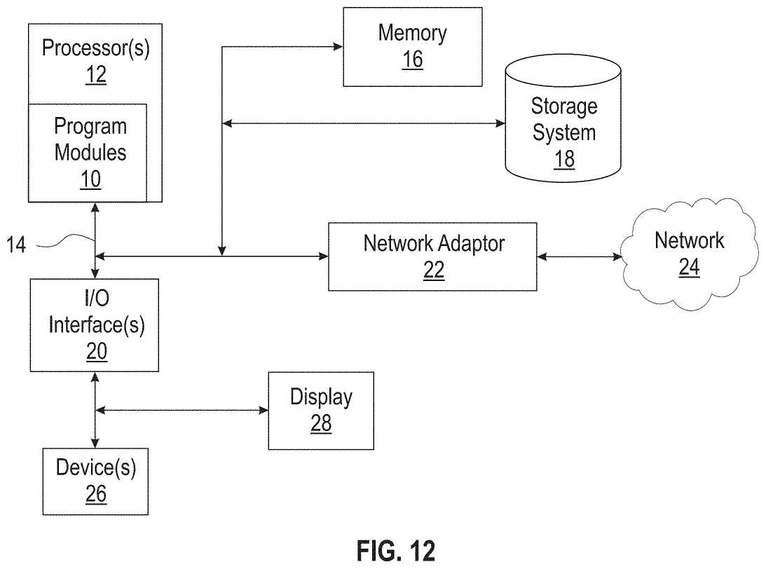

FIG. 12 illustrates an example computing system in accordance with the present invention that may provide the services and functions associated with the AI enabled accelerated process development framework and optimization for experimental designs. It is to be understood that the computer system depicted is only one example of a suitable processing system and is not intended to suggest any limitation as to the scope of use or functionality of embodiments of the present invention. For example, the system shown may be operational with numerous other general-purpose or special-purpose computing system environments or configurations. Examples of well-known computing systems, environments, and/or configurations that may be suitable for use with the system shown in FIG. 11 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. A non-limiting, exemplary implementation encompasses use in high performance computing system, e.g., executing MATLAB R2021b software package providing an interactive environment for high performance numerical computation and visualization.

In some embodiments, the computer system may be described in the general context of computer system executable instructions, embodied as program modules stored in memory 16, being executed by the computer system. Generally, program modules 10 may include routines, programs, objects, components, logic, data structures, and so on that perform particular tasks and/or implement particular input data and/or data types in accordance with the methods described herein with respect to FIGS. 1-11.

The components of the computer system may include, but are not limited to, one or more processors or processing units 12, a memory 16, and a bus 14 that operably couples various system components, including memory 16 to processor 12. In some embodiments, the processor 12 may execute one or more modules 10 that are loaded from memory 16, where the program module(s) embody software (program instructions) that cause the processor to perform one or more method embodiments of the present invention. In some embodiments, module 10 may be programmed into the integrated circuits of the processor 12, loaded from memory 16, storage device 18, network 24 and/or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system may include a variety of computer system readable media. Such media may be any available media that is accessible by computer system, and it may include both volatile and non-volatile media, removable and non-removable media.

Memory 16 (sometimes referred to as system memory) can include computer readable media in the form of volatile memory, such as random access memory (RAM), cache memory and/or other forms. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

The computer system may also communicate with one or more external devices 26 such as a keyboard, a pointing device, a display 28, etc.; one or more devices that enable a user to interact with the computer system; and/or any devices (e.g., network card, modem, etc.) that enable the computer system to communicate with one or more other computing devices. Such communication can occur via Input/Output (I/O) interfaces 20.

Still yet, the computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. Although not shown, other hardware and/or software components could be used in conjunction with the computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for multi-objective optimization in design of a physical device, the method comprising:
receiving, at one or more hardware processors, an input data comprising multiple unique historical experimental designs associated with a building of a physical device and corresponding historical performance measurements obtained using the built physical device;
receiving, at said one or more hardware processors, a specification of at least two target measurement values to be achieved by said built physical device; and
running, using one or more hardware processors, a prediction model trained to recommend a new design used to build said physical device, said recommended new design for simultaneously achieving said at least two target measurement values by said physical device; and
configuring, using the one or more hardware processors, one or more of: structures, materials, or process conditions used for building said physical device according to said recommended new design.

2. The method according to claim 1, wherein said multiple historical designs input data comprises data selected from: choices of materials for said physical device, one or more geometries of aspects of said physical device, a process condition used in the making of said physical device.

3. The method according to claim 1, further comprising:
building, using one or more hardware processors, based on said multiple unique historical experimental designs input data, the machine learned model trained for predicting a new experimental design given multiple target measurement values.

4. The method according to claim 1, wherein the machine learned model is a regularized multi-objective optimization function.

5. The method according to claim 4, wherein the regularized multi-objective optimization function comprises a target function for multi-objective optimization and a model uncertainty quantification term for calculating the prediction uncertainty of prediction models, said loss function for generating a scalar output value used for evaluating said multi-objective optimization.

6. The method according to claim 5, wherein said target function models operations embodied as one or more functions each operating on one or more experimental design input variables producing a respective multiple target measurement output.

7. The method according to claim 6, further comprising: modeling said target function as a logistic curve.

8. The method according to claim 6, further comprising: determining said uncertainty quantification term by performing one of: uncertainty quantification for a decision tree analysis and a multivariate adaptive regression splines analysis, or a principle component analysis PCA.

9. A method for multi-objective optimization in design of a physical device, the method comprising:
receiving, at one or more hardware processors, an input data comprising multiple unique historical experimental designs and corresponding historical performance measurements associated with a building of a physical device, said input data being insufficient for reliably training a single prediction function to predict a new design of said physical device that simultaneously achieves at least two target measurement values;
iteratively obtaining, using the one or more hardware processors, a sequence of surrogate prediction functions, each surrogate prediction function of said sequence designed to learn a relationship between the input historical experimental design data used to build said physical device and the at least two target measurement values;
running, at the one or more hardware processors, one of the successive surrogate prediction functions to optimally predict a new design for simultaneously achieving said at least two target measurement values by said physical device; and
configuring, using the one or more hardware processors, one or more of: structures, materials, or process conditions used for building said physical device according to said predicted new design.

10. The method according to claim 9, wherein, at each iteration, said obtaining a surrogate prediction function comprises:
evaluating, using the one or more processors, a current surrogate prediction function at one or more experimental design data points;
optimizing, using the one or more processors, the current surrogate prediction function based on said evaluating;
using said optimized current surrogate prediction function to acquire, using the one or more processors, a new experimental design data for successively improving an accuracy of the surrogate prediction function; and
repeating said surrogate prediction function evaluating, optimizing and acquiring of new experimental design data to obtain a best surrogate prediction function for optimally predicting said new design.

11. The method according to claim 10, wherein said evaluating a current surrogate prediction function comprises:
defining, by said one or more hardware processors, a search space of experimental designs;
successively partitioning, using said one or more hardware processors, said search space into a plurality of sub-regions, one or more sub-regions of said plurality comprising a new experimental design candidate for potentially optimizing said surrogate function, wherein said sub-region comprises a hyper-rectangle.

12. The method according to claim 11, wherein said successively partitioning said search space is an iterative process comprising, at each iteration:
first conducting, using said one or more hardware processors, a global search for identifying one or more optimal sub-regions that meet a partitioning criteria; and
then conducting at each said sub-region, using said one or more hardware processors, a local search for evaluating a candidate surrogate function value at one or more sampling points representing respective experimental designs within said sub-region; and
determining, based on said evaluating said candidate surrogate function, an optimal target solution at said iteration for a sub-region.

13. The method according to claim 12, wherein said conducting a local search at a sub-region comprises:
using a Gaussian process for building a local prediction model over the sub-region, said prediction model comprising a candidate surrogate function approximating said optimal target solution using Bayesian optimization.

14. The method according to claim 12, wherein said conducting a local search at a sub-region further comprises:
choosing, within a sub-region, a sampling point representing an experimental design by minimizing an prediction function, said prediction function defined as one of: an expected improvement with respect to a best function value; or an upper confidence bound.

15. A system for multi-objective optimization in design of a physical device, the system comprising:
a hardware processor and a non-transitory computer-readable memory coupled to the processor, wherein the memory comprises instructions which, when executed by the processor, cause the processor to:
receive an input data comprising multiple unique historical experimental designs and corresponding historical performance measurements associated with a building of a physical device, said input data being insufficient for reliably training a single prediction function to predict a new design of said physical device that simultaneously achieves at least two target measurement values;
iteratively obtain a sequence of surrogate prediction functions, each surrogate prediction function of said sequence designed to learn a relationship between the input historical experimental design data used to build said physical device and the at least two target measurement values;
run one of the successive surrogate prediction functions to optimally predict a new design for simultaneously achieving said at least two target measurement values by said physical device; and
configure one or more of: structures, materials, or process conditions used for building said physical device according to said predicted new design.

16. The system according to claim 15, wherein, at each iteration, to obtain a surrogate prediction function, said instructions, when executed by the processor, further cause the processor to:
evaluate a current surrogate prediction function at one or more experimental design data points;
optimize the current surrogate prediction function based on said evaluating;
using said optimized current surrogate prediction function to acquire a new experimental design data for successively improving an accuracy of the surrogate prediction function; and
repeat said prediction function evaluating, optimizing and acquiring of new experimental design data to obtain a best surrogate prediction function for optimally predicting said new design.

17. The system according to claim 10, wherein to evaluate a current surrogate prediction function, said instructions, when executed by the processor, further cause the processor to:
define a search space of experimental designs;
successively partition said search space into a plurality of sub-regions, one or more sub-regions of said plurality comprising a new design candidate for potentially optimizing said surrogate function, wherein said sub-region comprises a hyper-rectangle.

18. The system according to claim 11, wherein to successively partition said search space, said instructions, when executed by the processor, further cause the processor to perform an iterative process comprising, at each iteration:
first conducting a global search for identifying one or more optimal sub-regions that meet a partitioning criteria; and
then conduct, at each said sub-region, a local search for evaluating a candidate surrogate function value at one or more sampling points representing respective experimental designs within said sub-region; and
determine, based on said evaluating said candidate surrogate function, an optimal target solution at said iteration for a sub-region.

19. The system according to claim 12, wherein to conduct a local search at a sub-region, said instructions, when executed by the processor, further cause the processor to:
use a Gaussian process for building a local prediction model over the sub-region, said prediction model comprising a candidate surrogate function approximating said optimal target solution using a Bayesian optimization.

20. The system according to claim 12, wherein to conduct a local search at a sub-region, said instructions, when executed by the processor, further cause the processor to:
choose, within a sub-region, a sampling point representing an experimental design by minimizing an prediction function, said prediction function defined as one of: an expected improvement with respect to a best function value; or an upper confidence bound.

21. The method of claim 1, wherein the physical device is a microprocessor or computer memory device.
